(19) United States
(12) Patent Application Publication
(10) Pub. No.: US 2025/0022069 A1
(43) Pub. Date: Jan. 16, 2025

(54) SYSTEMS AND METHODS FOR TRIAL BALANCE ANALYTICS SECURITY MAINTENANCE

(71) Applicant: JPMORGAN CHASE BANK, N.A., New York, NY (US)

(72) Inventors: Viswas VENTRAPRAGADA, Coppell, TX (US); Subramanian BALAKRISHNAN, Frisco, TX (US); Alexia SERNA, Frisco, TX (US); Ruchi RAO, Bengaluru (IN); Zaid SHAIKH, Mumbai (IN); Bala MANIVANNAN, Irving, TX (US); Rajshree GUPTA, Gurugram (IN); Rashmi BHAGTANI, Mumbai (IN); Thomas LORD, Dover, NH (US); David T BYRNE, Cambridge, MA (US); Sarah H REIS, Swampscott, MA (US); Sindia TAYLOR, Quincy, MA (US)

(21) Appl. No.: 18/458,535

(22) Filed: Aug. 30, 2023

(30) Foreign Application Priority Data
Jul. 14, 2023 (IN) 202311047498

(51) Int. Cl. G06Q 40/12

(52) U.S. Cl. CPC G06Q 40/12

(57) ABSTRACT

Systems and methods for trial balance analytics security maintenance are disclosed. A method may include: (1) receiving, by an orchestrator computer program, data from a plurality of data sources; (2) extracting, by the orchestrator computer program, data elements from the data according to a definition; (3) validating, by the orchestrator computer program, the data elements; (4) retrieving, by the orchestrator computer program, metadata comprising threshold values for the extracted data elements, (5) retrieving exception rules from a database; (6) applying, by the orchestrator computer program, the exception rules to the data elements by comparing values for the data elements to corresponding threshold values; (7) identifying, by the orchestrator computer program, an exception based on the value for one of the data elements breaching the corresponding threshold value; and (8) performing, by the orchestrator computer program, automatic exception resolution on the data associated with the one data element.

### RELATED APPLICATIONS

This application claims priority to, and the benefit of, Indian patent application No. 202311047498, filed Jul. 14, 2023, the disclosure of which is hereby incorporated, by reference, in its entirety.

### BACKGROUND OF THE INVENTION

### 1. Field of the Invention

Embodiments generally relate to systems and methods for trial balance analytics security maintenance.

### 2. Description of the Related Art

Organizations often have teams dedicated to researching and closing out data exceptions currently. Depending on the exception, there are various research steps taken to validate it. These reviews are designed to identify potential upstream risk to stakeholders outside of the daily fund accounting function from which the data is extracted.

### SUMMARY OF THE INVENTION

Systems and methods for trial balance analytics security maintenance are disclosed. According to an embodiment, a method for trial balance analytics security maintenance may include: (1) receiving, by an orchestrator computer program, data from a plurality of data sources; (2) extracting, by the orchestrator computer program, data elements from the data according to a definition; (3) validating, by the orchestrator computer program, the data elements; (4) retrieving, by the orchestrator computer program, metadata comprising threshold values for the extracted data elements, (5) retrieving exception rules from a database; (6) applying, by the orchestrator computer program, the exception rules to the data elements by comparing values for the data elements to corresponding threshold values; (7) identifying, by the orchestrator computer program, an exception based on the value for one of the data elements breaching the corresponding threshold value; and (8) performing, by the orchestrator computer program, automatic exception resolution on the data associated with the one data element.

In one embodiment, the data may include accounting data.

In one embodiment, the definition may be based on Generally Accepted Accounting Principles.

In one embodiment, the orchestrator computer program validates the data elements by confirming that a set of the data elements is complete.

In one embodiment, the orchestrator computer program validates the data elements by confirming that a set of data elements may include data elements necessary for application of the exception rules.

In one embodiment, the method may further include validating, by the orchestrator computer program, the exception rules.

In one embodiment, the exception rules are based on historical exception analysis.

In one embodiment, the automatic exception resolution may include sending an event with corrected data to one of the data sources.

In one embodiment, the automatic exception resolution may include sending an event with corrected data to a downstream system.

In one embodiment, the automatic exception resolution may include closing out an exception in response to a set of data elements following a pattern similar to a previously reviewed set of data elements having a closed exception.

According to another embodiment, a system may include: a plurality of data sources; a database comprising exception rules; and an orchestrator computer program executed by an electronic device that receives data from the plurality of data sources, extracts data elements from the data according to a definition, validates the data elements, retrieves metadata comprising threshold values for the extracted data elements, retrieves the exception rules from the database, applies the exception rules to the data elements by comparing values for the data elements to corresponding threshold values, identifies an exception based on the value for one of the data elements breaching the corresponding threshold value, and performs automatic exception resolution on the data associated with the one data element.

In one embodiment, the orchestrator computer program validates the data elements by confirming that a set of the data elements is complete and/or by confirming that a set of data elements may include data elements necessary for application of the exception rules.

In one embodiment, wherein the exception rules are based on historical exception analysis.

In one embodiment, the automatic exception resolution may include sending an event with corrected data to one of the data sources.

In one embodiment, the automatic exception resolution may include sending an event with corrected data to a downstream system.

In one embodiment, the automatic exception resolution may include closing out an exception in response to a set of data elements following a pattern similar to a previously reviewed set of data elements having a closed exception.

According to another embodiment, a non-transitory computer readable storage medium, may include instructions stored thereon, which when read and executed by one or more computer processors, cause the one or more computer processors to perform steps comprising: receiving data from a plurality of data sources; extracting data elements from the data according to a definition, wherein the definition may be based on Generally Accepted Accounting Principles; validating the data elements by confirming that a set of the data elements is complete and by confirming that a set of data elements may include data elements necessary for application of the exception rules; retrieving metadata comprising threshold values for the extracted data elements, retrieving exception rules, wherein the exception rules are based on historical exception analysis; applying the exception rules to the data elements by comparing values for the data elements to corresponding threshold values; identifying an exception based on the value for one of the data elements breaching the corresponding threshold value; and performing automatic exception resolution on the data associated with the one data element.

In one embodiment, the automatic exception resolution may include sending an event with corrected data to one of the data sources.

In one embodiment, the automatic exception resolution may include sending an event with corrected data to a downstream system.

In one embodiment, the automated corrective action may include closing out an exception in response to a set of data elements following a pattern similar to a previously reviewed set of data elements having a closed exception.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for trial balance analytics security maintenance according to an embodiment.

FIG. 2 depicts a method for trial balance analytics security maintenance according to an embodiment.

FIG. 3 depicts an exemplary computing system for implementing aspects of the present disclosure.

### DETAILED DESCRIPTION OF PREFERRED EMBODIMENTS

Embodiments are directed to systems and methods for trial balance analytics security maintenance. In general, “trial balance” refers to a statement of debits and credits, with any mismatch indicating an error.

Embodiments may provide several technical advantages, including saving users' time, improving data accuracy, providing a reactive system, and providing better engagement with client and auditors. Embodiments may reduce or eliminate the amount of manual work for users, thus creating a more efficient and transparent system.

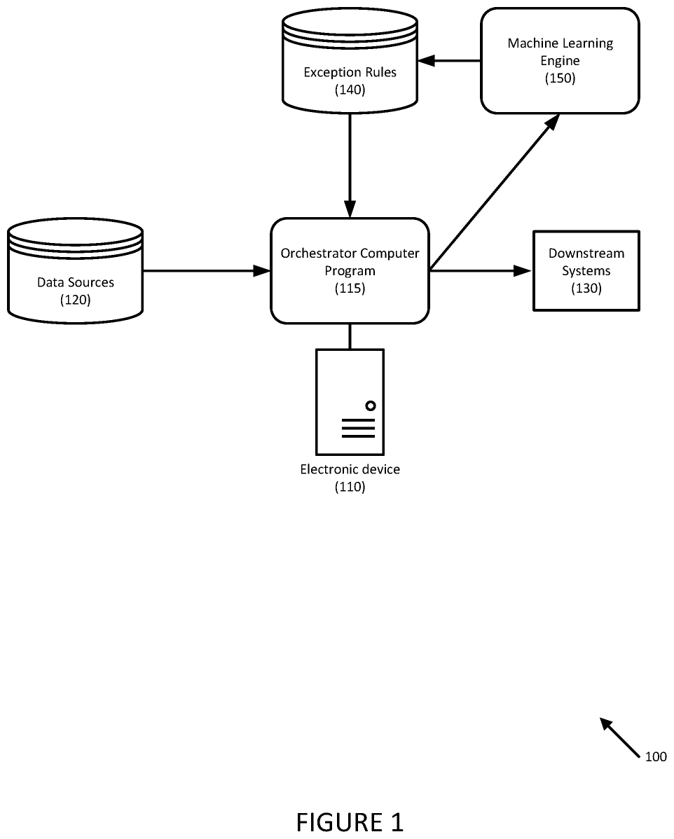

Referring to FIG. 1, a system for trial balance analytics security maintenance is disclosed according to embodiments. System 100 may include electronic device 110, such as a server (e.g., physical and/or cloud based), a computer (e.g., workstations, desktops, notebooks, laptops, tablets, etc.), a smart device, an Internet of Things (IoT) appliance, etc. Electronic device 110 may execute orchestrator computer program 115, which may receive data from data sources 120, extract data elements from the data, identify exceptions by applying rules from exception rules 140 to the data elements, and output results to one or more downstream system.

In one embodiment, data sources 120 may include systems providing any sort of accounting data, including data related to holdings, fund trends, transaction income, effective transactions, etc. The accounting data may include data that may be used to identify anomalies.

Exception rules may include rules that may be applied to identify exceptions in the data. The rules may be hard coded, may be dynamic, or may be based on historical exception analysis. For example, machine learning engine 150 may be trained with historical data from data sources 120 and the results of orchestrator computer program to set rules that may be used to identify exceptions.

In one embodiment, the exceptions may predict the occurrence of a future issue if the data trends continue. In another embodiment, the exceptions may identify an issue with the data source. Examples of exceptions may include income exceptions (e.g., negative accrued income), holding exceptions (e.g., shares are greater than 0 band market value is less than $0), income exceptions, Realized Gain Loss (RGL) exceptions, amortization exceptions, capital gains tax exceptions, SWAP exceptions, illogical transaction exceptions, miscellaneous income exceptions, etc.

Downstream systems 130 may receive the output of orchestrator computer program 115. For example, downstream systems 130 may receive a notification that an exception has been identified. Downstream system 130 may take an action, such as providing a notification or alert, in response to an exception being identified. Downstream system 130 may perform self-healing on data sources 120 if, for example, the exception is a result of data source 120.

In one embodiment, orchestrator computer program 115 may continuously analyze patterns in the accounting data received from data sources 120 and may take any necessary corrective actions with accounting data from data sources 120 or may take the corrective action with downstream systems 120. In one embodiment, the corrective action may be identified from historical data.

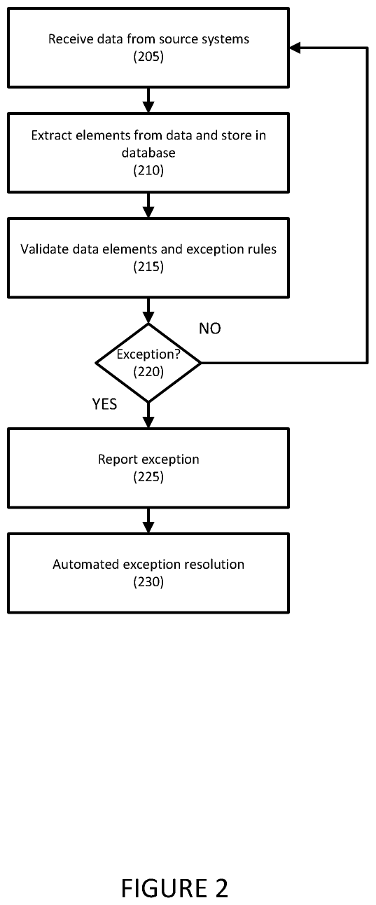

Referring to FIG. 2, a method for trial balance analytics security maintenance is disclosed according to an embodiment.

In step 205, a computer program, such as an orchestrator computer program, may receive data from a plurality of data sources. In one embodiment, the data sources may include sources of accounting data, including data related to holdings, fund trends, transaction income, effective transactions, etc.

In step 210, the computer program may extract elements from the data and may store the extracted elements in a database. In one embodiment, the elements may be extracted according to a business definition, such as Generally Accepted Accounting Principles (“GAAP). For example, all the necessary transactional data may be grouped into a corresponding table in a database.

Examples of extracted elements may include elements related to trial balances, income data, fund level attributes, transactional data, and positions data.

In step 215, the orchestrator computer program may validate the data elements and exception rules to be applied to the data elements. Exception rules may include rules that may be applied to identify exceptions in the data elements. The exception rules may be hard coded, may be dynamic, or may be based on historical exception analysis.

In one embodiment, validation may include, for example, checking if the data set has the correct elements required to process the rules, checking if the received data set is complete before running the exceptions, checking if the rule applies to the data itself, etc. An example of such a check is to validate that transaction rules are only applied to transactional data.

In step 220, the orchestrator computer program may check to see if there is an exception. In one embodiment, for each exception rule, the orchestrator computer program may retrieve the appropriate metadata from the database and may apply this against the relevant data elements for the exception rule.

In one embodiment, the metadata may be associated with values that may be thresholds for triggering an exception. In one embodiment, the values may be set manually; in another embodiment, the values may be dynamic and may be set using a machine learning engine that is trained on historical data.

In one embodiment, the exception rules may compare the values of the extracted elements to values for the metadata. For example, if a transaction rule is looking for the assets element to equal “X”, the value “X” is part of the metadata that is retrieved specifically for that transaction rule. If this criterion is met, an exception would be triggered.

If there is not an exception, the process may return to step 205.

If there is an exception, in step 225, the orchestrator computer program may report the exception to a stakeholder, may generate one or more reports, etc. For example, the reports may include trial balance analytics exception reports, trial to trial exception reports, class to fund exception reports, capital gains tax, exception reports, multiple books of record support report, etc. The reports may be generated and provided to a user device.

In step 230, the orchestrator computer program may perform automated exception resolution. For example, historical actions may be analyzed to identify the correct resolution for each exception. The adjusted entries may be posted to downstream financial reporting applications, or the errors may be corrected in the upstream systems that provided the data.

Examples of corrective actions may include closing out an exception if the analyzed data follows a similar pattern as that of previously reviewed exceptions that have been closed.

In one embodiment, the corrective action may be based on historical actions taken with similar exceptions. For example, historical exceptions may be reviewed to identify the corrective action(s) that were taken against a similar exception, and a similar corrective action may be taken.

In one embodiment, the orchestrator computer program may send the corrected data to upstream systems, and, in embodiments, may correct the data at the data source. For example, the orchestrator computer program may replace data at the data source with the corrected data by sending an event to update the source system.

In one embodiment, the orchestrator computer program may correct data in downstream systems by sending an event to update the data to any downstream systems.

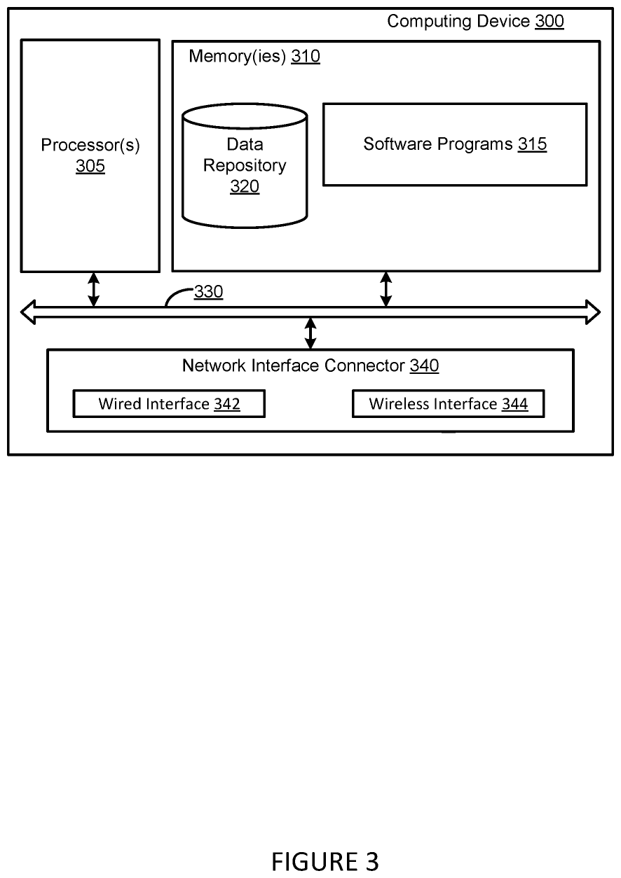

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for trial balance analytics security maintenance, comprising:
receiving, by an orchestrator computer program, data from a plurality of data sources;
extracting, by the orchestrator computer program, data elements from the data according to a definition;
validating, by the orchestrator computer program, the data elements;
retrieving, by the orchestrator computer program, metadata comprising threshold values for the extracted data elements,
retrieving exception rules from a database;
applying, by the orchestrator computer program, the exception rules to the data elements by comparing values for the data elements to corresponding threshold values;
identifying, by the orchestrator computer program, an exception based on the value for one of the data elements breaching the corresponding threshold value; and
performing, by the orchestrator computer program, automatic exception resolution on the data associated with the one data element.

2. The method of claim 1, wherein the data comprises accounting data.

3. The method of claim 1, wherein the definition is based on Generally Accepted Accounting Principles.

4. The method of claim 1, wherein the orchestrator computer program validates the data elements by confirming that a set of the data elements is complete.

5. The method of claim 1, wherein the orchestrator computer program validates the data elements by confirming that a set of data elements comprises data elements necessary for application of the exception rules.

6. The method of claim 1, further comprising:
validating, by the orchestrator computer program, the exception rules.

7. The method of claim 1, wherein the exception rules are based on historical exception analysis.

8. The method of claim 1, wherein the automatic exception resolution comprises sending an event with corrected data to one of the data sources.

9. The method of claim 1, wherein the automatic exception resolution comprises sending an event with corrected data to a downstream system.

10. The method of claim 1, wherein the automatic exception resolution comprises closing out an exception in response to a set of data elements following a pattern similar to a previously reviewed set of data elements having a closed exception.

11. A system, comprising:
a plurality of data sources;
a database comprising exception rules; and
an orchestrator computer program executed by an electronic device that receives data from the plurality of data sources, extracts data elements from the data according to a definition, validates the data elements, retrieves metadata comprising threshold values for the extracted data elements, retrieves the exception rules from the database, applies the exception rules to the data elements by comparing values for the data elements to corresponding threshold values, identifies an exception based on the value for one of the data elements breaching the corresponding threshold value, and performs automatic exception resolution on the data associated with the one data element.

12. The system of claim 11, wherein the orchestrator computer program validates the data elements by confirming that a set of the data elements is complete and/or by confirming that a set of data elements comprises data elements necessary for application of the exception rules.

13. The system of claim 11, wherein the exception rules are based on historical exception analysis.

14. The system of claim 11, wherein the automatic exception resolution comprises sending an event with corrected data to one of the data sources.

15. The system of claim 11, wherein the automatic exception resolution comprises sending an event with corrected data to a downstream system.

16. The system of claim 11, wherein the automatic exception resolution comprises closing out an exception in response to a set of data elements following a pattern similar to a previously reviewed set of data elements having a closed exception.

17. A non-transitory computer readable storage medium, including instructions stored thereon, which when read and executed by one or more computer processors, cause the one or more computer processors to perform steps comprising:
receiving data from a plurality of data sources;
extracting data elements from the data according to a definition, wherein the definition is based on Generally Accepted Accounting Principles;
validating the data elements by confirming that a set of the data elements is complete and by confirming that a set of data elements comprises data elements necessary for application of the exception rules;
retrieving metadata comprising threshold values for the extracted data elements,
retrieving exception rules, wherein the exception rules are based on historical exception analysis;
applying the exception rules to the data elements by comparing values for the data elements to corresponding threshold values;
identifying an exception based on the value for one of the data elements breaching the corresponding threshold value; and
performing automatic exception resolution on the data associated with the one data element.

18. The non-transitory computer readable storage medium of claim 17, wherein the automatic exception resolution comprises sending an event with corrected data to one of the data sources.

19. The non-transitory computer readable storage medium of claim 17, wherein the automatic exception resolution comprises sending an event with corrected data to a downstream system.

20. The non-transitory computer readable storage medium of claim 17, wherein the automated corrective action comprises closing out an exception in response to a set of data elements following a pattern similar to a previously reviewed set of data elements having a closed exception.
